(19) United States
(12) Patent Application Publication
(10) Pub. No.: US 2015/0226329 A1
(43) Pub. Date: Aug. 13, 2015

(54) HYDRAULIC CYLINDER MADE OF HYBRID COMPOSITE LAMINATE, IN PARTICULAR FOR HIGH-POWER APPLICATIONS

(71) Applicant: RI-BA COMPOSITES - S.R.L. CON UNICO SOCIO, Faenza (IT)

(72) Inventor: Andrea Bedeschi, Faenza (IT)

(21) Appl. No.: 14/427,592

(22) PCT Filed: Sep. 12, 2013
(86) PCT No.: PCT/IB2013/058499

§ 371 Date: Mar. 11, 2015

(30) Foreign Application Priority Data
Sep. 12, 2012 (IT) BO2012A000481

(51) Int. Cl. F16J 10/02; F15B 15/14

(52) U.S. Cl. CPC F16J 10/02; F15B 15/14

(57) ABSTRACT

A hydraulic cylinder, in particular for high-power applications, comprising a first element, provided, in turn, with an outer sleeve, which is provided with a symmetry axis; and a second element provided with a piston accommodated inside said outer lining of said outer sleeve mobile along the symmetry axis between a first extreme lower limit stop position and a second extreme upper limit stop position; and a rod stiffly connected to the piston; wherein at least one element of either said first or said second elements are at least partially made of a hybrid composite laminate provided with fibers made to differentiate performance in terms of stiffness and strength of said at least one element of either said first or said second element.

### TECHNICAL FIELD

The present invention relates to a hydraulic cylinder made of hybrid composite laminate, in particular for high-power applications.

### PRIOR ART

As known, hydraulic cylinders comprise a first element, essentially consisting of a outer sleeve provided with a symmetry axis, and a second element, comprising, in turn, a piston accommodated in said outer sleeve mobile along the symmetry axis between a first lower extreme limit stop position and a second upper extreme limit stop position, and a rod stiffly connected to the piston.

The hydraulic cylinders normally used in particular for high-power applications, e.g. earth-moving machines or applications in the nautical or aeronautical sectors, are made of metallic material; the use of metallic materials does not allow to obtain good performance in terms of weight of the hydraulic cylinder itself.

Hydraulic cylinders either entirely or partially made of composite material have been suggested in order to overcome this drawback. For example US2008173172, EP174117, DE19647506 and DE102006047412 describe hydraulic cylinders comprising an outer sleeve, a piston accommodated in said outer sleeve and a rod stiffly connected to the piston; wherein at least one element of either the outer sleeve, or the piston or the rod is made of a composite hybrid laminated material. In other words, in these types of hydraulic cylinders, at least one element of either the outer sleeve or the assembly formed by the piston and by the rod is made of a composite material.

However, this type of hydraulic cylinders have some disadvantages.

In the case in which the rod is made of composite material, the rod itself is not sufficiently stiff in the axial direction and this causes problems of elastic instability under compression (phenomenon also known as “buckling”).

Instead, in the case in which the outer sleeve is made of composite material, while providing good performance in terms of stiffness in the axial direction the outer sleeve is not sufficiently stiff in the circling direction, causing an undesired “pumping” effect of the outer sleeve itself, which under the bias of high working pressures tends to bulge radially. Over time, this pumping phenomenon causes a rather rapid decay of the seal inside the outer sleeve and the wear of the seal itself with risk of leakage between the chambers defined within the cylinder.

In order to solve this drawback, the thickness of the composite material used for the outer sleeve must be considerably increased to attempt to obtain the same stiffness in the circling direction with the composite material that would be obtained by using metallic materials, but the increase of thickness obviously also implies a considerable increase of weight and cost.

### DESCRIPTION OF THE INVENTION

It is the object of the present invention to provide a hydraulic cylinder made of hybrid composite laminate for high-power applications, which is free from the drawbacks of the prior art, has good performance in terms of weight, stiffness and strength, allows to optimize structural efficiency and is easy and cost-effective to make at the same time.

It is a further object of the present invention to provide a machine for high-power applications, in particular for earth-moving, which is free from the drawbacks of the prior art, has high reliability over time and is easy and cost-effective to make at the same time.

According to the present invention, a hydraulic cylinder made of hybrid composite laminate is provided, in particular for high-power applications as disclosed in claim 1 and in any subsequent claim depending from claim 1.

According to the present invention, a machine for high-power applications, in particular for earth-moving, is provided as disclosed in claim 8 and in any subsequent claim depending from claim 8.

### BRIEF DESCRIPTION OF THE DRAWINGS

The present invention will now be described with reference to the accompanying drawings, which show a non-limitative embodiment thereof, in which:

FIG. 1 shows a perspective and a side elevation view of a hydraulic cylinder made of hybrid composite laminate, in particular for high-power applications made in accordance with the present invention; and

FIG. 2 is a section view taken along line II-II of the hydraulic cylinder in FIG. 1.

### PREFERRED EMBODIMENTS OF THE INVENTION

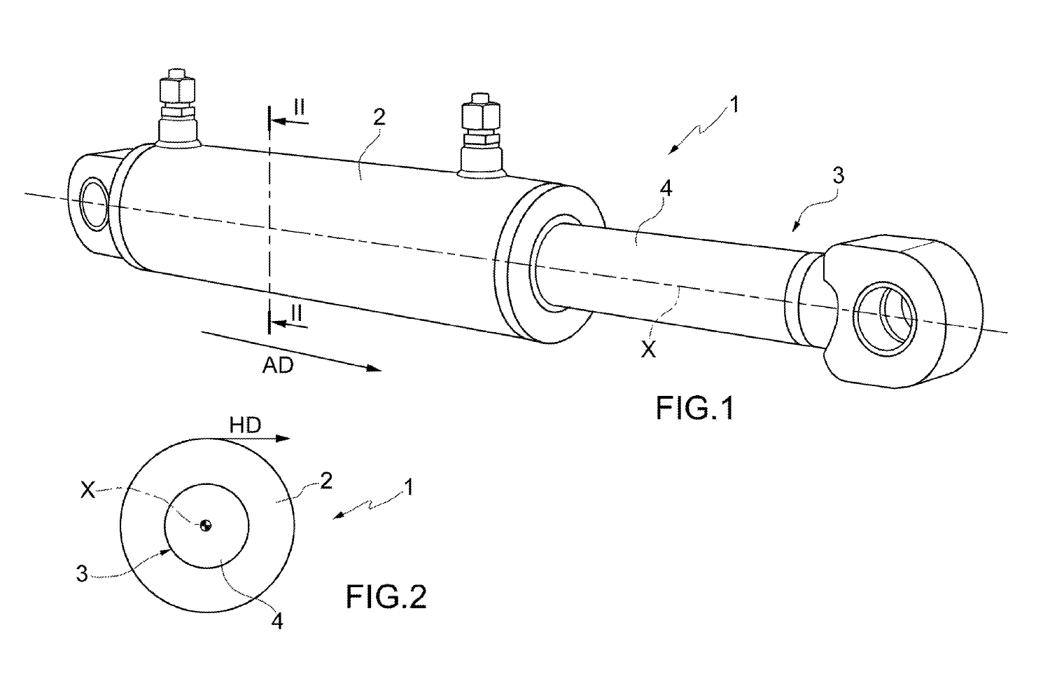

In FIGS. 1 and 2, reference numeral 1 indicates a hydraulic cylinder as a whole. The hydraulic cylinder 1 is advantageously, but not exclusively applied to earth-moving machines (such as, for example, excavators and large farming tractors) and, more in general, to high-power machines.

The hydraulic cylinder 1 comprises a first element, which essentially consists of an outer sleeve 2. The outer sleeve 2 essentially has a cylindrical symmetry about a symmetry axis X.

The hydraulic cylinder 1 then comprises a second element 3, which comprises, in turn, a piston (not shown) accommodated in sliding manner in the outer sleeve 2 and mobile along the symmetry axis X between a first lower extreme limit stop position and a second upper extreme limit stop position, and vice versa. The second element 3 further comprises a rod 4, which explicates the motion, is stiffly connected to the piston and is mobile, together with the piston, along the symmetry axis X between the first lower extreme limit stop position and the second upper extreme limit stop position, and vice versa.

The hydraulic cylinder 1 is at least partially made of a hybrid composite laminate provided with fibers which, as described below, are made to differentiate the performance in terms of stiffness and strength along different directions.

According to a first variant, the hydraulic cylinder 1 is entirely made of a hybrid composite laminate provided with fibers made to differentiate performance in terms of stiffness and strength along the various directions.

In other words, both the, first element 2 and the second element 3 are both either entirely or partially made of a hybrid composite laminate (because the outer sleeve 2 may be provided, for example, with metallic terminal flanges and/or with an inner liner, also made of metallic material) to differentiate performance in terms of stiffness and strength along the various directions.

According to a second variant, the hydraulic cylinder 1 is made only in part, not entirely, of a hybrid composite laminate provided with fibers made to differentiate performance in terms of stiffness and strength along the various directions. In other words, according to the different embodiments, either the first element 2 or the second element 3 are alternatively made either completely or partially in a hybrid composite laminate.

Thus, according to a first embodiment only the first element 2 (i.e. the outer sleeve 24 is made either entirely or partially made of a hybrid composite laminate (because the outer sleeve 2 may be provided, for example, with metallic terminal flanges and/or with an inner liner, also made of metallic material), the hybrid composite laminate being provided with fibers made to differentiate performance in terms of stiffness and strength along the various directions.

According to a second embodiment, only the second element 3 (i.e. the piston and/or the rod 4) is made either completely or partially of a hybrid composite laminate provided with,fibers made to differentiate performance in terms of stiffness and strength along the various directions. The following three cases may occur in this second embodiment:
only the rod 4 is made of a hybrid composite laminate provided with fibers made to differentiate performance in terms of stiffness and strength along the various directions;
only the piston is made of a hybrid composite laminate provided with fibers made to differentiate performance in terms of stiffness and strength along the various directions; and
both the rod 4 and the piston are made of a hybrid composite laminate provided with fibers made to differentiate performance in terms of stiffness and strength along the various directions.

In the second variant, the portions of the first element 2 or of the second element 3 which, according to the various embodiments and on a case-by-case basis are not made of hybrid composite laminate, are instead made of any material chosen from: steel, composite material, aluminum, magnesium etc.

In particular, according to a preferred embodiment, the outer sleeve 2 is either completely or partially made of a hybrid composite laminate provided with different carbon fibers. In particular, the outer sleeve 2 is either completely or partially made of a hybrid composite laminate provided with very high elastic modulus carbon fibers in the circling direction HD (perpendicular to symmetry axis X), preferably comprised between 290 and 935 GPa, and high strength and intermediate elastic module carbon fibers, preferably comprised between 200 and 290 GPa, in the axial direction AD (parallel to symmetry axis X) made to differentiate the performance of the outer sleeve 2 in terms of stiffness and strength along the circling direction HD and the axial direction AD.

In particular, the very high modulus elastic fibers in the circling direction HD are, for example, pitch-based fibers (obtained from pitch) or the like; while high strength and intermediate elastic modulus fibers in the axial direction AD are PAN-based fibers (obtained from polyacrylonitrile).

Said hybrid composite laminate is made alternatively by only superimposing layers of very high elastic modulus carbon fibers in the circling direction HD and of layers of high strength and intermediate elastic modulus in axial direction AD without interweaving; or by superimposing and interweaving, in the form of cloth, layers of very high elastic carbon fiber in the circling direction HD and high strength and intermediate elastic modulus layers of carbon fibers in the axial direction AD according to predetermined weight ratios as a function of the required structural needs.

Furthermore, according to the preferred variant, the second element 3 (i.e. the piston and/or the rod 4) is made either entirely or partially of a hybrid composite laminate of different carbon fibers. In particular, the second element 3 (i.e. the piston and/or the rod 4) is either completely or partially made of a hybrid composite laminate provided with very high elastic modulus carbon fibers in the axial direction AD (parallel to symmetry axis X), preferably comprised between 290 and 935 GPa, and of high strength and intermediate elastic module carbon fibers, preferably comprised between 200 and 290 GPa, in the circling direction HD (perpendicular to symmetry axis X) precisely to differentiate the performance of the second element 3 in terms of stiffness and strength along the circling direction HD and the axial direction AD. particular, the very high modulus elastic fibers in the axial direction AD are, for example, pitch-based fibers (obtained from pitch) or the like; while high strength and intermediate elastic modulus fibers in the circling direction HD are PAN-based fibers (obtained from polyacrylonitrile).

Also in this case, said hybrid composite laminate is made alternatively by only superimposing layers of very high elastic modulus carbon fibers in the circling direction HD and layers of high strength and intermediate elastic modulus in axial direction AD without interweaving; or by superimposing and interweaving in the form of cloth of layers of very high elastic carbon fiber in the circling direction HD and high strength and intermediate elastic modulus layers of carbon fibers in the axial direction AD according to predetermined weight ratios as a function of the required structural needs.

In the description above, said hybrid composite laminate provided with fibers made to differentiate performance in terms of stiffness and strength is made indifferently either by means of any manufacturing technology chosen from the following automatic or manual technologies (of known type and not described in detail): roll wrapping, filament winding, fiber placement, hand lay-up, RTM, VARTM etc.

In essence, the common feature of the, various variants of the hydraulic cylinder 1 described above is the possibility of obtaining high performance in terms of strength and stiffness where necessary in both the outer sleeve 2 (i.e. in the circling direction) and in the assembly formed by the piston and by the rod 4 (i.e. in the axial direction).

The hydraulic cylinder 1 described above has many advantages because it is light and such to allow to obtain high performance in terms of stiffness and strength such to allow to optimize structural efficiency.

Furthermore, a machine for high-power applications, in particular earth-moving machines, such as excavators or large farming tractors, which comprises at least one hydraulic cylinder 1 of the type described above has many advantages by effect of the weight reduction which derives from the use of said hydraulic cylinders 1.

For example, the hydraulic cylinder 1 may be advantageously applied to crane booms in which the hydraulic cylinders 1 are overhangingly mounted; the lightening which derives from the use of hydraulic cylinders 1 described above allows to improve performance and reduce the need to ballast the machine body.

Furthermore, the hydraulic cylinder 1 may be advantageously applied, for example, to the transport sector (aeronautic and/or nautical) in which the lightening which derives from the use of the hydraulic cylinders 1 described above allows to significantly reduce the return on investment time by increasing the payload considerably.

Finally, the hydraulic cylinder 1 may be advantageously applied also in corrosive environments because the hybrid composite materials are less subject to corrosion than the metallic materials normally used for making hydraulic cylinders 1.

1. A hydraulic cylinder for high-power applications comprising:
a first element, which comprises, in turn, an outer sleeve, which is provided with a symmetry axis;
a second element, which comprises a piston, accommodated inside said outer sleeve mobile along the symmetry axis between a first lower extreme limit stop position and a second upper extreme limit stop position, and vice versa; and
a rod stiffly connected to the piston;
the hydraulic cylinder is characterized in that at least one element of either said first or said second element is at least partially made of a hybrid composite laminate material provided with carbon fibers, made to differentiate the performance of the at least one element in the direction parallel and perpendicular to the symmetry axis in terms of stiffness and strength; said hybrid composite laminate material is made by superimposing layers of very high elastic modulus carbon fibers arranged in a first direction and layers of very high strength and intermediate elastic modulus carbon fibers in a second direction.

2. A hydraulic cylinder according to claim 1, wherein the first element is made of a hybrid composite laminate provided with very high elastic modulus carbon fibers, preferably comprised between 290 and 935 Gpa, in a circling direction perpendicular to the symmetry axis, and very high strength and intermediate elastic module carbon fibers, preferably comprised between 200 and 290 Gpa, in an axial direction parallel to the symmetry axis so as to differentiate the performance of the second element in terms of stiffness and strength along said circling direction and said axial direction.

3. A hydraulic cylinder according to claim 1, wherein the second element is made of a hybrid composite laminate provided with very high elastic modulus carbon fibers, preferably comprised between 290 and 935 Gpa, in an axial direction parallel to the symmetry axis and high strength and intermediate elastic modulus carbon fibers, preferably comprised between 200 and 290 Gpa, in a circling direction perpendicular to the symmetry axis so as to differentiate the performance of the second element in terms of stiffness and strength along said circling direction and said axial direction.

4. A hydraulic cylinder according to claim 1, wherein both the first element and the second element are at least partially made of a hybrid composite laminate.

5. A hydraulic cylinder according to claim 1, wherein said hybrid composite laminate is made by superimposing first layers of fibers arranged in a first direction and second layers of fibers, which are different from the first layers of fibers, in a second direction; said superimposition being carried out without interweaving said first layers of fibers in the first direction and said second layers of fibers in the second direction.

6. A hydraulic cylinder according to claim 1, wherein said hybrid composite laminate is manufactured by superimposing and interweaving, so as to form a cloth, first layers of fibers in a first direction and second layers of fibers, which are different from the first layers of fibers, in a second direction according to predetermined weight ratios.

7. A hydraulic cylinder according to claim 1, wherein the hybrid composite laminate is made by means of any manufacturing technology chosen from the following manual or automatic technologies: roll wrapping, filament winding, fiber placement, hand lay-up, RTM, VARTM etc.

8. A machine for high-power applications, in particular for earth-moving machines, comprising at least one hydraulic cylinder made according to claim 1.
